(19) United States
(12) Patent Application Publication
(10) Pub. No.: US 2026/0045996 A1
(43) Pub. Date: Feb. 12, 2026

(54) Type I Single Panel Codebook Enhancement

(71) Applicant: Apple Inc., Cupertino, CA (US)

(72) Inventors: Haitong Sun, Saratoga, CA (US); Ankit Bhamri, Bad Nauheim (DE); Chunxuan Ye, San Diego, CA (US); Dawei Zhang, Saratoga, CA (US); Hong He, San Jose, CA (US); Huaning Niu, San Jose, CA (US); Wei Zeng, Saratoga, CA (US)

(21) Appl. No.: 19/276,721

(22) Filed: Jul. 22, 2025

Related U.S. Application Data
(60) Provisional application No. 63/680,940, filed on Aug. 8, 2024.

(51) Int. Cl. H04B 7/06

(52) U.S. Cl. CPC H04B 7/0626; H04B 7/0617

(57) ABSTRACT

A method for wireless communication, the method comprising: selecting a set of orthogonal spatial bases of an antenna array for supporting up to eight orthogonal layers for up to 128 ports, wherein each spatial basis of the set can support up to two orthogonal layers based on a first horizontal phase compensation factor value that is associated with a first layer of the two orthogonal layers for a first spatial basis and based on a second, opposite horizontal phase compensation factor value that is associated with a second layer of the two orthogonal layers for the first spatial basis; and causing transmission of a radio signal using the set of spatial bases, or preparing, for transmission, feedback specifying the preferred spatial bases as part of CSI (Channel State Information).

### CLAIM OF PRIORITY

This application claims priority under 35 U.S.C. § 119(e) to U.S. Patent Application Ser. No. 63/680,940, filed on Aug. 8, 2024, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation (5G) New Radio (NR). The wireless communication networks facilitate mobile broadband service using technologies such as OFDM, multiple input multiple output (MIMO), advanced channel coding, massive MIMO, beamforming, and/or other features.

Multiple-input multiple output (MIMO) enables a base station (e.g., a node, evolved node eNB, a next generation node gNB, and so forth) to send data streams to users over time-frequency resources. MIMO configuration includes a configuration of a number of antennas and layers. A user equipment (UE) and base station carry predefined tables, called codebooks, defining the number of antenna ports and layers. Type I codebooks define beamforming for MIMO for single user MIMO (SU-MIMO). Type II codebooks can be generally used for multi-user MIMO.

There can be infinite number of vectors and matrices to form a beam in the exact and arbitrary direction, but it is practically not feasible to allow the infinite number of beamforming vectors and metrics. There are therefore a predefined number of beamform vectors and matrices for this purpose. The base station can estimate the downlink channel quality from uplink signal, such as from the sounding reference signal (SRS) or physical uplink shared channel demodulation reference signal (PUSCH DMRS). The base station selects a best codebook matrix best fit for the downlink transmission based on channel reciprocity. Alternatively, the base station can estimate the downlink channel quality by the channel state information (CSI) report from UE and select the best codebook matrix best fit for the downlink transmission.

### SUMMARY

In an aspect, a method for wireless communication includes selecting a set of orthogonal spatial bases of an antenna array for supporting up to eight orthogonal layers for up to 128 ports, wherein each spatial basis of the set can support up to two orthogonal layers based on a first horizontal phase compensation factor value that is associated with a first layer of the two orthogonal layers for a first spatial basis and based on a second, opposite horizontal phase compensation factor value that is associated with a second layer of the two orthogonal layers for the first spatial basis; and causing transmission of a radio signal using the set of spatial bases, or preparing, for transmission, feedback specifying the preferred spatial bases as part of Channel State Information (CSI).

In some implementations that may include one or more of the implementations or aspects described herein, selecting the set of orthogonal spatial bases comprises reporting a set of values comprising a value of a vertical oversampling factor, a horizontal oversampling factor, a vertical spatial basis value, and a horizontal spatial basis value, the set of values representing orthogonal discrete Fourier transform (DFT) vectors.

In some implementations that may include one or more of the implementations or aspects described herein, the set of values for each spatial basis vᵢ is reported as

$$\{ {q}_{1}^{i} , {q}_{2}^{i} , {n}_{1}^{i} , {n}_{2}^{i} \} ,$$

where i=1, 2, 3, 4, and wherein the vertical oversampling factor and the horizontal oversampling factor are selected based on

$$\{ {q}_{1}^{i} , {q}_{2}^{i} \} = \{ {q}_{1}^{j} , {q}_{2}^{j} \} , i \neq j ,$$

where i is a horizontal spatial basis index and j is a vertical spatial basis index.

In some implementations that may include one or more of the implementations or aspects described herein, four spatial bases are selected for the set of orthogonal spatial bases, the method further comprising selecting, for at least two spatial bases of the four spatial bases, a same oversampling factor in a horizontal direction and, for the at least two spatial bases, selecting a different spatial basis in the horizontal direction.

In some implementations that may include one or more of the implementations or aspects described herein, four spatial bases are selected for the set of orthogonal spatial bases, the method further comprising selecting, for at least two spatial bases of the four spatial bases, a same oversampling factor in a vertical direction and, for the at least two spatial bases, selecting a different spatial basis in the vertical direction.

In some implementations that may include one or more of the implementations or aspects described herein, four spatial bases are selected for the set of orthogonal spatial bases, the method further comprising selecting, for at least two spatial bases of the four spatial bases, a same oversampling factor in a horizontal direction and in a vertical direction, and, for the at least two spatial bases, selecting a different spatial basis in the horizontal direction and/or in the vertical direction.

In some implementations that may include one or more of the implementations or aspects described herein, three spatial bases are selected for the set of orthogonal spatial bases for supporting rank 5, and wherein an orphan layer is allocated to a third spatial basis.

In some implementations that may include one or more of the implementations or aspects described herein, four spatial bases are selected for the set of orthogonal spatial bases for supporting rank 5, and wherein the first spatial basis is allocated to two layers.

In some implementations that may include one or more of the implementations or aspects described herein, four spatial bases are selected for the set of orthogonal spatial bases for supporting rank 5, and wherein a third spatial basis is allocated to two layers.

In some implementations that may include one or more of the implementations or aspects described herein, three spatial bases are selected for the set of orthogonal spatial bases for supporting rank 6, and wherein each of the three spatial bases is allocated two layers.

In some implementations that may include one or more of the implementations or aspects described herein, four spatial bases are selected for the set of orthogonal spatial bases for supporting rank 6, and a second spatial basis and a fourth spatial basis are allocated single layers, and wherein the first and second spatial bases are grouped in a same codeword.

In some implementations that may include one or more of the implementations or aspects described herein, four spatial bases are selected for the set of orthogonal spatial bases for supporting rank 6, and the first spatial basis and the second spatial basis are each allocated two layers.

In some implementations that may include one or more of the implementations or aspects described herein, the method includes selecting a number of spatial bases from among three spatial bases or four spatial bases based on channel state information reported by a user equipment.

In some implementations that may include one or more of the implementations or aspects described herein, the method includes selecting a number of spatial bases from among three spatial bases or four spatial bases based on a configuration by a base station.

In some implementations that may include one or more of the implementations or aspects described herein, the method includes selecting a number of spatial bases from among three spatial bases or four spatial bases based on a predefined value.

In some implementations that may include one or more of the implementations or aspects described herein, four spatial bases are selected for the set of orthogonal spatial bases for supporting rank 8, and wherein each spatial bases is allocated two layers.

In some implementations that may include one or more of the implementations or aspects described herein, the method includes configuring an orphan layer location with at least one of the selected spatial bases using a channel state information (CSI) report.

In some implementations that may include one or more of the implementations or aspects described herein, the CSI report specifies the orphan location in part 1.

In some implementations that may include one or more of the implementations or aspects described herein, the orphan layer location enables two or more layers with signal to noise ratio (SNR) values within a threshold value of each other to be grouped together in a same codeword.

In some implementations that may include one or more of the implementations or aspects described herein, the orphan layer is a last layer for a rank 5 transmission configuration.

In some implementations that may include one or more of the implementations or aspects described herein, the orphan layer is a third or sixth layer for a rank 6 transmission configuration.

In some implementations that may include one or more of the implementations or aspects described herein, the orphan layer is a third layer for a rank 7 transmission configuration.

In some implementations that may include one or more of the implementations or aspects described herein, a last spatial basis is allocated to an orphan layer.

In some implementations that may include one or more of the implementations or aspects described herein, multiple spatial basis are allocated to orphan layers.

In some implementations that may include one or more of the implementations or aspects described herein, a user equipment indicates a spatial basis for allocation to an orphan layer.

In some implementations that may include one or more of the implementations or aspects described herein, a particular, fixed layer is allocated to an orphan layer.

In an aspect, a non-transitory computer storage medium encoded with instructions that, when executed by one or more computers, cause the one or more computers to perform the methods described herein.

In an aspect, a system comprising one or more processors and one or more storage devices on which are stored instructions that are operable, when executed by the one or more processors, to cause the one or more processors to perform the methods described herein.

In an aspect, an apparatus comprising one or more baseband processors configured to perform the methods described herein.

In an aspect, one or more processors comprising circuitry that executes instructions to cause a user equipment (UE) to perform the methods described herein.

### BRIEF DESCRIPTION OF THE FIGURES

FIG. 1 illustrates a wireless network.

FIG. 2A illustrates an example codebook structure.

FIG. 2B illustrates an example codebook structure.

FIG. 3 illustrates a flowchart of an example process.

FIG. 4 illustrates a user equipment (UE).

FIG. 5 illustrates an access node.

FIG. 6 illustrates an apparatus including baseband processor circuitry.

### DETAILED DESCRIPTION

This document describes systems and processes for enhancing type I single panel codebooks in NR networks to support up to 128 channel state information reference signal (CSI-RS) ports for MIMO operations on a single panel. The type I single panel solution can be enhanced for MIMO to support a greater number of ports than previously supported, as subsequently described herein.

Generally, there are type I codebooks and type II codebooks for SU-MIMO and MU-MIMO, respectively. Type I codebooks have a relatively low overhead of CSI feedback. However, the resolution of the CSI feedback, especially the pre-coding matrix indicator (PMI) feedback, is relatively low. Type II codebooks have a higher reporting overhead. The size of the CSI report is relatively larger, and the resolution of the PMI is relatively high. The PMI enables a UE to report a preferred precoding for downlink transmissions on the physical downlink shared channel (PDSCH). The PMI can indicate the preferred precoding for MIMO. For larger antenna configurations, such as 64 transceiver active antenna, the PMI can indicate a preferred precoding for both MIMO and beamforming.

Previously, the type 1 single panel supports 2×2 MIMO without beamforming, such as when using a single cross polar panel antenna. Type I single panel also provides support for 4×4 and 8×8 MIMO using larger antenna configurations which are also able to support beamforming. For example, the legacy type I solutions support up to 32 CSI-RS ports per resource. Type 1 solutions support PMI reporting in two stages. The first stage provides wideband information which does not change rapidly over time. This can involve beam selection, or beam group selection. The second stage provides sub-band information which changes more rapidly over time. This can involve beam selection from within a group and phase shift selection for co-phasing between polarizations, layers and antenna panels.

The type 1 single panel solutions described herein can support up to 128 CSI-RS ports, as more than 32 antenna elements can be utilized on a single panel. Increasing the number of antenna elements and the number of CSI-RS ports can improve MIMO performance and also beamforming in some embodiments.

To increase the number of CSI-RS ports supported, the systems and processes described herein enhance the type I codebook. Type I codebooks support up to rank 8. In CSI reporting, several of the UE's resources are reported including a layer indicator (LI) and a rank indicator (RI). The rank indicator specifies the number of layers preferred by a UE.

The type I codebook design is based on the following aspects. A single spatial basis is selected with structured PMI construction. Each rank 1/2, rank 3/4, rank 5/6, rank 7 and rank 8 of the CSI are associated with respective different structures. For example, within Rank 3/4, a different structures is adopted when a number of CSI-RS ports is less than 16 or when the number of CSI-RS ports is the greater than or equal to 16.

The type I single panel codebook enhancement for up to 128 ports described herein is focused on rank 5/6/7/8. The type I single panel codebook configurations described herein include descriptions of each of the spatial basis selection for the codebook and handling of the orphan layer, where applicable. As described herein, the spatial basis for the UE indicates what beam is used for transmission/reception by the UE and can result in improved signal to noise ratio (SNR) or otherwise maximize the throughput of the transmission.

The spatial basis refers to the different precodings that correspond to different spatial directions for the beam. The spatial basis depends on the direction of the target device (e.g., the location of the UE relative to the base station) and on the reflection of how the signal travels between the UE and base station. The UE attempts to match the spatial basis by selecting the preferred precoding to be applied across different antennas to be used for transmission to match the radio propagation for maximizing the signal to noise ratio (SNR) or otherwise maximize the throughput of the transmission. The systems and processes described herein select the spatial basis for up to 128 ports.

In some implementations, a single spatial basis may be used to cover up to eight ranks. The UE can select up to four independent spatial bases. When the number of layers is odd there will be an orphan layer. The UE attempts to cover the orphan layer in addition to the other layers.

The systems and processes described herein that extend the type I single panel codebook to 128 ports enables use of a greater number of antenna elements and improved resolution for the PMI. The UE can therefore have improved transmission and reception quality, improving communication throughput.

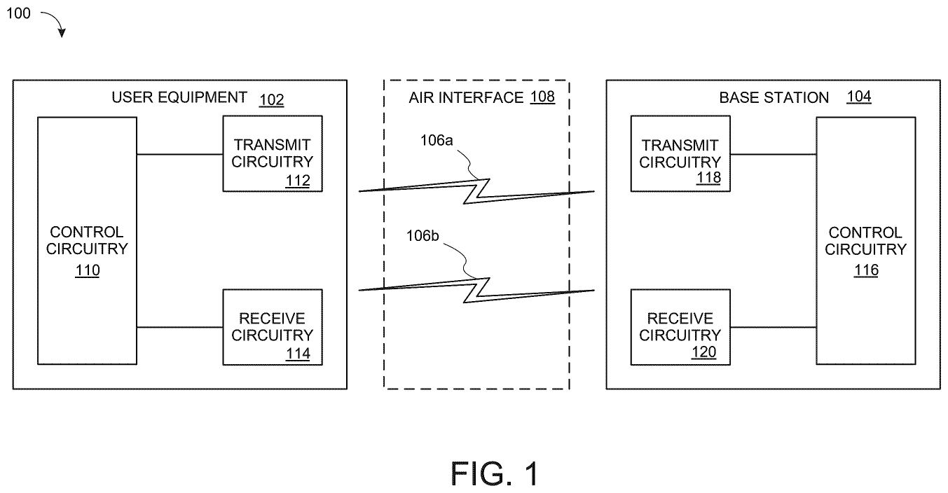

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-E-UTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example: laptop computers, smartphones, tablet computers, machine-type devices (such as smart meters or specialized devices for healthcare), intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

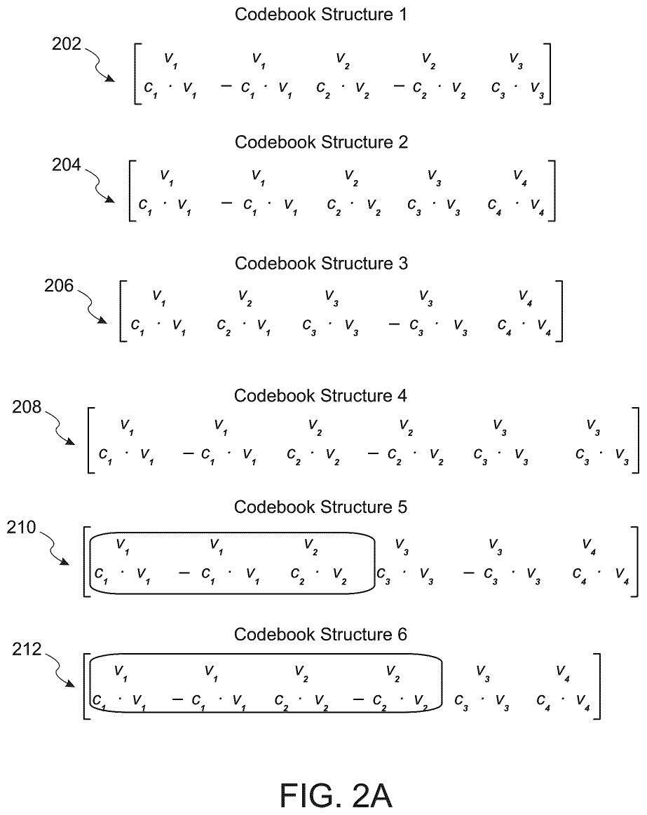

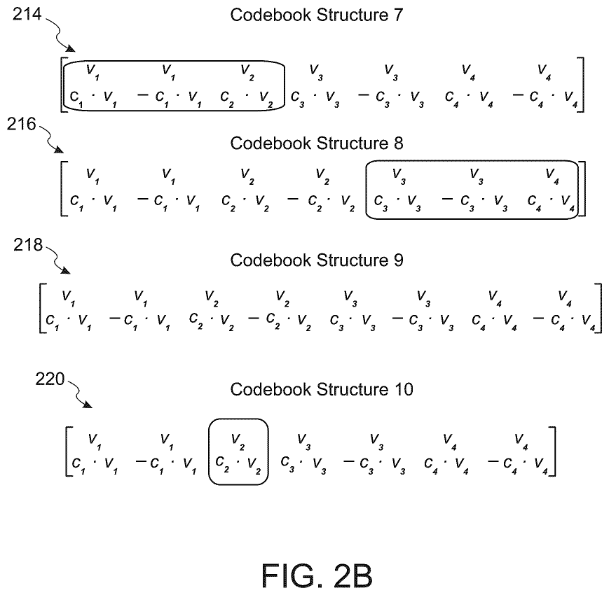

FIGS. 2A-2B illustrates example codebook structures 202, 204, 206, 208, 210, 212, 214, 216, 218, and 220 for configuration of the type I single panel codebook to support ranks 5, 6, 7, and 8. A UE or the network can select up to four spatial bases for reporting. Typically it is difficult to find an independent spatial basis for each layer. For example, for rank five, the UE should determine five independent spatial bases. The spatial basis that are selected are orthogonal. Determining the five orthogonal spatial bases is difficult, and the difficulty increases for rank 8 (e.g., finding 8 independent, orthogonal spatial bases).

To simplify the selection, the UE is instead configured to find up to four independent spatial bases. The UE may use the four selected independent spatial bases to cover up to rank 8 by utilizing horizontal polarization of multiple layers.

The UE can select one independent spatial basis to cover two layers because the antenna architectures relies on both vertical and horizontal polarization. For example, if there are 128 ports but only 64 antenna locations, the 64 antenna locations are distributed in the antenna array such that there is equal space in a vertical direction and equal space in the horizontal direction. For the two dimensional (2D) antenna placement, at each antenna there is both the vertically polarized antenna and the horizontally polarized antenna. At each location, the UE can support vertical polarization and/or horizontal polarization (V-po/H-po), and the 64 antenna locations can support 128 ports.

In an example, each selected or reported spatial basis may be used to support up to two orthogonal layers (rank 2). Among the two orthogonal layers, the UE can utilize vertical polarization of both layers and use a same spatial basis without phase compensation. The UE can utilize horizontal polarization of both layers and use a same spatial basis with a phase compensation of opposite sign, such as shown in Equation (1):

$${W}^{H} = [ \begin{matrix}v & v \\ cv & - cv\end{matrix} ] \qquad ( 1 )$$

wherein v is the selected/reported spatial basis, c=e^{jθ} is a phase compensation applied to the horizontal polarization of the first layer, and −c is the phase compensation applied to the horizontal polarization of the second layer. For each two orthogonal layers, θ is quantized and reported by the UE. Specifically, once the UE selects a spatial basis, the spatial basis can be applied for horizontal polarization and the same spatial basis can be rotated by a phase value (rotated by an angle). The angle is the complex value, as shown previously. For each element c, the phase is rotated by e^{jθ} so that the there is a phase rotation. For example, in the first layer, the UE can report a phase rotation by a value of θ. In the other layer on the horizontal polarization, the UE can rotate the phase 180 degrees (e.g., −cv), or changing the sign of the phase compensation factor.

The result of the polarization shown in the matrix of Equation 1 results in two orthogonal layers for the spatial bases. Such a configuration enables the UE to reduce the number of spatial bases that are selected and support additional ports. For rank eight, which is a maximum supported rank, the UE selects only the four orthogonal spatial bases to support 128 ports.

The UE can ensure that the spatial bases are orthogonal as now described. In legacy systems, the 16 groups of spatial bases cover maximum 32 ports. Generally, for a type I single panel codebook enhancement for up to 128 ports, the spatial basis is created by discrete Fourier transform (DFT) vectors. The UE can create orthogonal spatial bases in the vertical and horizontal domain based on the DFT vectors. Each group of spatial bases has N₁N₂ orthogonal DFT vectors, where N₁ is the number of antenna elements vertically, N₂ is the number of antenna elements horizontally, and the total number of ports is 2N₁N₂ for a total number of antenna locations N₁N₂. In other words, the two dimensional DFT vectors are transformed into a one dimensional vector of spatial bases.

The antennae each have equal distance vertically and equal distance horizontally for the linear antenna array. The spatial bases in the same group are mutually orthogonal. The spatial bases in a second group are not orthogonal to the spatial bases of a first group. Each of those spatial bases has a certain spatial resolution. For example, in the vertical domain, the spatial basis resolution is 2π/N₁ (e.g., 360 degrees/N₁). The DFT vector is uniformly sampled in each direction, and so in the horizontal domain the resolution is 2π/N₂ (e.g., 360 degrees/N₂). For larger values of N₁, N₂, the spatial resolution is higher and there are more orthogonal beams. For example, each orthogonal beam has a smaller angle difference compared to the neighboring beams.

The UE can further increase the spatial basis resolution by oversampling in the vertical domain or horizontal domain by a factor of O. There are total O₁O₂=16 factor for oversampling of the spatial bases, e.g., O₁=O₂=4 for oversampling in the most complex example. The UE may use oversampling to generate multiple groups of orthogonal DFT vectors. For example, given a particular O₁ and O₂ selection, such as 0 and 0 in both the vertical and horizontal domains, the UE can have N₁N₂ orthogonal vectors. Given another sampling factor value for either O₁ and O₂, the UE can have another N₁N₂ orthogonal vectors. In other words, for each set of values for O₁ and O₂, the set of N₁N₂ vectors are orthogonal. Across different oversampling factors, the DFT vectors are not orthogonal. By oversampling, the UE can have multiple groups of orthogonal vectors, and each group has the same spatial resolution. Across different orthogonal vectors in different oversampling factors the spatial basis are orthogonal, but those groups of vectors are phase shifted compared to the other group of DFT vectors.

The UE is configured for selection and report of spatial basis for type I single panel codebook enhancement for up to 128 ports. The selection and report of the spatial bases requires that the UE select and report four values including {q₁, q₂, n₁, n₂}. Here, q₁, q₂ are the oversampling factors for the vertical and horizontal domains. Here, n₁, n₂ are the spatial domains of the antennae. The selection/report of oversampling factor (group) is {q₁, q₂}, q₁=0, 1, . . . , O₁−1, q₂=0, 1, . . . , O₂−1, or 0 to a value of 1 less than the oversampling factor in each direction. The selection/report of spatial basis within the group is {n₁, n₂}, n₁=0, 1, . . . , N₁−1, n₂=0, 1, . . . , N₂−1. This represents a selection of n₁*N₂+n₂-th spatial basis. The reporting of q₁, q₂ values represents which group of orthogonal vectors the UE will use and within that group which spatial basis is used (of the N₁ N₂ available spatial bases) for a beam.

The reporting of {q₁, q₂, n₁, n₂} by the UE describes a configuration of a single spatial basis. To select four spatial bases, as previously described, the UE ensures that the selected bases are orthogonal. For type I single panel codebook enhancement for up to 128 ports, to support rank 5/6/7/8, when up to four spatial bases can be selected and reported by the UE, including v₁, v₂, v₃, v₄, the UE selects and reports vᵢ as

$$\{ {q}_{1}^{i} , {q}_{2}^{i} , {n}_{1}^{i} , {n}_{2}^{i} \} ,$$

where i=1, 2, 3, 4. This is because the principle of the PMI is that each layer should have an orthogonal precoder. Every two spatial bases should be orthogonal to each other.

To ensure different spatial bases vᵢ are orthogonal (e.g., that orthogonal spatial bases are selected), the UE can select based on the following examples. In a first example, the UE selects a same oversampling factor for all spatial bases such that

$$\{ {q}_{1}^{i} , {q}_{2}^{i} \} = \{ {q}_{1}^{j} , {q}_{2}^{j} \} , i \neq j .$$

In other words, the same group of DFT vectors are used for spatial basis selection, and in addition, the UE selects a different spatial basis within the group. For example,

$$\{ {n}_{1}^{i} , {n}_{2}^{i} \} \neq \{ {n}_{1}^{j} , {n}_{2}^{j} \} , i \neq j .$$

Here, {a₁, a₂}={b₁, b₂} means that a₁=b₁ and a₂=b₂. Here, {a₁, a₂}≠{b₁, b₂} means that a₁≠b₁ and/or a₂≠b₂. In a second example, the UE can select and report a different oversampling factor for different spatial bases. For at least one of the vertical or horizontal directions, the UE selects and reports a same oversampling factor with a different orthogonal spatial basis selection. In other words, for spatial bases vᵢ and vⱼ, i≠j, either of the following conditions are applied. A first condition is that

$${q}_{1}^{i} = {q}_{1}^{j} , and {n}_{1}^{i} \neq {n}_{1}^{j} ,$$

or that the same oversampling value is selected in the vertical direction for each group, but a different spatial basis is selected in the vertical direction for each group. In a second condition,

$${q}_{2}^{i} = {q}_{2}^{j} , and {n}_{2}^{i} \neq {n}_{2}^{j} ,$$

or the same oversampling value is selected in the horizontal direction for each group, but a different spatial basis is selected in the vertical direction for each group. In another example, both of these two conditions can apply such that the same oversampling factor is selected in both directions, but the same spatial basis is not selected in both directions. For the second example, the UE selection can be orthogonal in one direction, and the end result is that the spatial basis is orthogonal.

The UE can be configured to support rank 5 for the type I single panel codebook enhancement for up to 128 ports. Here, the UE has selected spatial bases. The spatial bases can be selected as previously discussed to create a precoding matrix for rank 5/6/7/8. For rank 5, there are two examples. In a first example, the UE has selected and reported three spatial bases {v₁, v₂, v₃}. For a spatial basis v, the UE uses the values c₁, c₂, c₃ for phase compensation as previously described. Here, as described previously, c=e^{jθ}, i=1, 2, 3, 4 is a phase compensation applied to the horizontal polarization of each layer. Here, cᵢ={1, j} if cᵢ is paired with −cᵢ. Here, cᵢ={1, j, −1, −j} if cᵢ is not paired with −cᵢ. To reduce reporting overhead, a restriction can be applied in which cᵢ=cⱼ and i≠j.

An example codebook structure is shown below:

$$[ \begin{matrix}{v}_{1} & {v}_{1} & {v}_{2} & {v}_{2} & {v}_{3} \\ {c}_{1} * {v}_{1} & - {c}_{1} * {v}_{1} & {c}_{2} * {v}_{2} & - {c}_{2} * {v}_{2} & {c}_{3} * {v}_{3}\end{matrix} ] \qquad Codebook Structure 1$$

where {v₁, v₂, v₃} are the three spatial bases, and c₁, c₂, and c₃ are the phase compensation values. The UE may use v₁ for the first and the second layers to configure two orthogonal layers based on phase compensation value of c₁. The UE may use v₂ for the third and fourth layers based on the phase compensation value of c₂. The UE may use v₃ for the fifth layer based on the phase compensation value of c₃. If the spatial basis is used to generate two layers, because the coefficient operation for the phase compensation is a negating operation (coefficient of −1), the phase compensation is the same and only 1 bit is needed to signal the value (e.g., a 90 degree compensation is considered). If the phase compensation is used in the orphan layer (e.g., rank 5), or the last layer in which there is not a pair of phase compensation values c₃ and −c₃, then the value of c₃ can have one more signaling bit because in this case each of the positive and negative values are valid and produce different phase compensations.

In a second example, the UE has selected and reported four spatial bases {v₁, v₂, v₃, v₄}. For a spatial basis v, the UE uses the values c₁, c₂, c₃ and c₄ for phase compensation. An example codebook structure is shown below:

$$[ \begin{matrix}{v}_{1} & {v}_{1} & {v}_{2} & {v}_{3} & {v}_{4} \\ {c}_{1} * {v}_{1} & - {c}_{1} * {v}_{1} & {c}_{2} * {v}_{2} & {c}_{3} * {v}_{3} & {c}_{4} * {v}_{4}\end{matrix} ] \qquad Codebook Structure 2$$

where {v₁, v₂, v₃, v₄} are the four spatial bases and c₁, c₂, c₃, and c₄ are the phase compensation values. The UE may use v₁ for the first and the second layers to configure two orthogonal layers based on phase compensation value of c₁. The UE may use v₂ for the third layer based on the phase compensation value of c₂. The UE may use v₃ for the fourth layer based on the phase compensation value of c₃. The UE may use v₄ for the fifth layer based on the phase compensation value of c₄. As discussed previously, if the spatial basis is used to generate two layers, because the coefficient operation for the phase compensation is a negating operation (coefficient of −1), the phase compensation is the same and only 1 bit is needed to signal the value (e.g., a 90 degree compensation is considered). For the third, fourth, and fifth layers, or the last layer in which there is not a pair of phase compensation values, then the values of c₂, c₃, and c₄ can have one more signaling bit because in this case each of the positive and negative values are valid and produce different phase compensations.

The particular spatial bases {v₁, v₂, v₃, v₄} used for two layers can vary among any of the four selected spatial bases as a variation. Codebook Structure 3 shows an example variation in which v₃ is used for two layers (e.g., layers 3 and 4), but other such variations are possible with any of the spatial bases{v₁, v₂, v₃, v₄}. An example codebook structure is shown below:

$$[ \begin{matrix}{v}_{1} & {v}_{2} & {v}_{3} & {v}_{3} & {v}_{4} \\ {c}_{1} * {v}_{1} & {c}_{2} * {v}_{2} & {c}_{3} * {v}_{3} & - {c}_{3} * {v}_{3} & {c}_{4} * {v}_{4}\end{matrix} ] \qquad Codebook Structure 3$$

Generally, the first spatial basis is assigned to multiple layers. For rank 5, the layer-to-codework mapping allocates the first and the second layer to the first codeword, then the third, fourth and fifth layers to the second codeword. As a result, assigning the first spatial basis to two layers ensures that the spatial bases applying to two layers will not be split among two codewords.

To support rank 6, the UE can select three spatial bases {v₁, v₂, v₃} or four spatial bases {v₁, v₂, v₃, v₄}, similar to supporting rank 5 as previously described. For rank 6, when three spatial bases are used, each spatial basis {v₁, v₂, v₃} may be used to create two horizontal layers as described previously. An example codebook for this configuration is shown below:

$$[ \begin{matrix}{v}_{1} & {v}_{1} & {v}_{2} & {v}_{2} & {v}_{3} & {v}_{3} \\ {c}_{1} * {v}_{1} & - {c}_{1} * {v}_{1} & {c}_{2} * {v}_{2} & - {c}_{2} * {v}_{2} & {c}_{3} * {v}_{3} & - {c}_{3} * {v}_{3}\end{matrix} ] \qquad Codebook Structure 4$$

When four spatial bases are used, any two of {v₁, v₂, v₃, v₄} may be used to create two horizontal layers. In other words, two of the spatial bases would be used to create four orthogonal layers, and the remaining two spatial bases are each used for one horizontal layer. Two example codebook structures are shown below:

$$[ \begin{matrix}{v}_{1} & {v}_{1} & {v}_{2} & {v}_{3} & {v}_{3} & {v}_{4} \\ {c}_{1} * {v}_{1} & - {c}_{1} * {v}_{1} & {c}_{2} * {v}_{2} & {c}_{3} * {v}_{3} & - {c}_{3} * {v}_{3} & {c}_{4} * {v}_{4}\end{matrix} ] \qquad Codebook Structure 5$$

$$[ \begin{matrix}{v}_{1} & {v}_{1} & {v}_{2} & {v}_{2} & {v}_{3} & {v}_{4} \\ {c}_{1} * {v}_{1} & - {c}_{1} * {v}_{1} & {c}_{2} * {v}_{2} & - {c}_{2} * {v}_{2} & {c}_{3} * {v}_{3} & {c}_{4} * {v}_{4}\end{matrix} ] \qquad Codebook Structure 6$$

As previously described, there are different ways to partition the layers among the spatial bases. Generally, the layer to codeword mapping partitions with the cut at first three layers and last three layers. Once the base station uses the precoder to transmit the PDSCH, the UE reports the estimated channel quality indicator (CQI), the split of the layer to code word mapping is three and three, as defined in the Fifth Generation (5G) specification 3GPP 38.211 Because of this even split, the suggested Codebook Structure 5, for example, is more balanced for reporting purposes. For each codeword there are three layers, and the first two layers would be created by one orthogonal spatial basis and the last layer would be created by another a spatial basis, resulting in a symmetric reporting. More specifically, the first spatial bases v₁ may be used for covering two layers and the remaining spatial bases may be used for single layers because this creates a simpler codeword.

The UE always selects a fourth spatial basis v₄ for rank 7 and rank 8 coverage. In this example, no matter which rank is reported, the UE uses the fourth spatial basis for coverage. If the UE uses only three spatial bases {v₁, v₂, v₃} when only rank 5 and rank 6 are required, the number of spatial bases selected is different between rank 5/6 and rank 7/8. If the UE always uses four spatial bases {v₁, v₂, v₃, v₄} for coverage regardless of the rank being covered, the result can be a more unified codebook design for all scenarios for ranks 5/6/7/8.

For type I single panel codebook enhancement for up to 128 ports, the UE can support ranks 5/6 by selecting three spatial bases or four spatial bases. In a first example, the UE reports the spatial bases dynamically as part of CSI, such as in CSI part 1. The UE reporting can be carried in the CSI part 1.

Generally, the spatial basis is heavily dependent on the actual channel. For example, in some channels there are a lot of reflectors, and each reflection can be a different angle. If a signal goes in one angle it can be reflected and received at the UE side. When there are multiple reflectors physically in the channel, the UE uses multiple spatial bases. If the UE has less reflection with the base station, the UE selects three spatial bases. Thus, the best number of configured spatial bases can depend on the channel. In some implementations, four spatial basis can perform better than three spatial bases. In some implementations, the fourth spatial basis can perform worse than the other three. The performance depends on the radio propagation in the field.

In an embodiment, because of the impact on performance of the channel condition, the UE can improve performance by checking whether three or four spatial bases are preferable for a given physical condition. While, as previously described, the network can configure the number of spatial bases, the UE typically can best determine the channel condition by measuring the downlink signal using CSI. The UE can then select the spatial bases and report to the network, based on that analysis.

In a second example, the spatial bases for the codeword are configured by the network using radio resource control (RRC). The network can specify the configuration in a CSI report setting such as CSI-ReportConfig. In a third example, the configuration is predefined. As earlier described, when rank 7/8 are covered, the UE uses four spatial bases, and the UE does not need to select or report a number of spatial bases to be used in that context.

For type I single panel codebook enhancement for up to 128 ports, to support rank 7, the UE or network selects and reports four spatial bases {v₁, v₂, v₃, v₄}. For the example codebook structures 7 and 8, cᵢ=e^{jθ}, i=1, 2, 3, 4, as discussed previously.

$$Codebook Structure 7$$

$$[ \begin{matrix}{v}_{1} & {v}_{1} & {v}_{2} & {v}_{3} & {v}_{3} & {v}_{4} & {v}_{4} \\ {c}_{1} * {v}_{1} & - {c}_{1} * {v}_{1} & {c}_{2} * {v}_{2} & {c}_{3} * {v}_{3} & - {c}_{3} * {v}_{3} & {c}_{4} * {v}_{4} & - {c}_{4} * {v}_{4}\end{matrix} ]$$

$$Codebook Structure 8$$

$$[ \begin{matrix}{v}_{1} & {v}_{1} & {v}_{2} & {v}_{2} & {v}_{3} & {v}_{3} & {v}_{4} \\ {c}_{1} * {v}_{1} & - {c}_{1} * {v}_{1} & {c}_{2} * {v}_{2} & - {c}_{2} * {v}_{2} & {c}_{3} * {v}_{3} & - {c}_{3} * {v}_{3} & {c}_{4} * {v}_{4}\end{matrix} ]$$

In each of codebook structure examples 7 and 8, three spatial bases are used for six orthogonal layers. As discussed previously, the is one orphan layer in which one of the spatial bases {v₁, v₂, v₃, v₄} covers only one layer and no phase compensation is needed for the other layer. In codebook structure 7, v₂ is associated with the orphan layer. In codebook structure 8, v₄ is associated with the orphan layer. Each of these codebook structures shows a different mapping, and other mappings are possible in which the orphan layer is associated with v₃ or v₁. Generally, for rank 7, the layer to codeword mapping allocates the first three layers to the first codeword, then the last four layers to the second codeword. As a result, codebook structure 7 avoids splitting a pair of orthogonal layers with the same spatial basis across two codewords.

In an aspect, for type I single panel codebook enhancement for up to 128 ports, to support rank 8, four spatial basis {v₁, v₂, v₃, v₄} are selected and reported. The codebook structure 9 is shown below. Here, cᵢ=e^{jθ}, i=1, 2, 3, 4, as discussed previously.

$$Codebook Structure 9$$

$$[ \begin{matrix}{v}_{1} & {v}_{1} & {v}_{2} & {v}_{2} & {v}_{3} & {v}_{3} & {v}_{4} & {v}_{4} \\ {c}_{1} * {v}_{1} & - {c}_{1} * {v}_{1} & {c}_{2} * {v}_{2} & - {c}_{2} * {v}_{2} & {c}_{3} * {v}_{3} & - {c}_{3} * {v}_{3} & {c}_{4} * {v}_{4} & - {c}_{4} * {v}_{4}\end{matrix} ]$$

As previously described, each spatial basis {v1, v2, v3, v4} has a phase compensation to enable the spatial basis to cover two orthogonal layers.

The orphan layer handling for supporting rank 5, rank 6, and rank 7 is now described. For ranks 5/6/7, there can be one layer that is associated with a spatial basis with no orthogonal, phase compensated counterpart. More specifically, the orphan layer is defined that there is no pairing layer for which the same spatial basis is selected, and a horizontal polarization is compensated with opposite sign. The particular spatial basis that is associated with the orphan layer can be configured by the UE or the network.

A location of the orphan layer can be selected dynamically or can be statically defined. In a first example, the location of the orphan layer is hardcoded in the specification. For example, for rank 5, the orphan layer can be set as always being the last layer (5th layer). For example, for rank 6, when four spatial bases are selected, the orphan layer can be the 3rd layer and/or the 6th layer. For example, for rank 7, the orphan layer is the 3rd layer. In a second example, the UE can report the location of the orphan layer, as described previously. Example codebook structure 10 shows an example in which the orphan layer is associated with the second spatial bases v₂.

$$Codebook Structure 10$$

$$[ \begin{matrix}{v}_{1} & {v}_{1} & {v}_{2} & {v}_{3} & {v}_{3} & {v}_{4} & {v}_{4} \\ {c}_{1} * {v}_{1} & - {c}_{1} * {v}_{1} & {c}_{2} * {v}_{2} & {c}_{3} * {v}_{3} & - {c}_{3} * {v}_{3} & {c}_{4} * {v}_{4} & - {c}_{4} * {v}_{4}\end{matrix} ]$$

By allowing the location of the orphan layer to shift based on the measured channel, a more efficient grouping can be achieved. The configuration can shift which layers are bundled together to form the same codeword. The configuration groups layers having similar SNR values in the same codeword because the same codeword uses a same coding and modulation scheme for each layer. If there are multiple layers that have different SNR values, then using the same coding and modulation scheme to map to all the different layers with different SNRs results in a larger loss. The UE can report which grouping of similar layers with similar SNRs should occur for a same codeword. The UE reporting this configuration in the CSI may add only a few bits to the total CSI (e.g., out of a few hundred bits) but achieve a high efficiency gain.

The type I single panel codebook enhancement for up to 128 ports can support rank 5/6/7/8 when multiple spatial bases {v₁, v₂, v₃, v₄} are selected and reported by the UE. Previously, the location (rank) associated with the orphan layer was described. Here, the actual spatial basis {v₁, v₂, v₃, v₄} allocated to the orphan layer is described.

The orphan layer can be configured as follows. A fixed spatial basis can be allocated to the orphan layer. For example, the last spatial basis can be allocated to an orphan layer, when there is one orphan layer. In some implementations, the spatial basis of the last layer and the second layer are allocated to orphan layers when there are two orphan layers. In another option, the UE reports which spatial basis should be allocated to each orphan layer. The UE can therefore decide which spatial basis should be reported for the orphan spatial basis, and then determine, once the orphan spatial basis is selected, which layers should be allocated to orphan spatial basis.

In an example, the UE can freely select a spatial basis {v₁, v₂, v₃, v₄} such that every spatial basis {v₁, v₂, v₃, v₄} can be selected from all the spatial bases. The UE may use any permutation for {v₁, v₂, v₃, v₄} when the CSI signaling/reporting enables this selection, and a more efficient transmission can be achieved. When this flexibility is enabled, the location of the orphan layer and which spatial basis should be allocated to the orphan layer is less important because the UE can group the spatial bases efficiently. If a particular order is assumed, a report overhead can be reduced, but the flexibility of the UE to select from any spatial bases {v₁, v₂, v₃, v₄} is reduced. In this later case, the orphan layer configuration affects transmission efficiency more than the previous case.

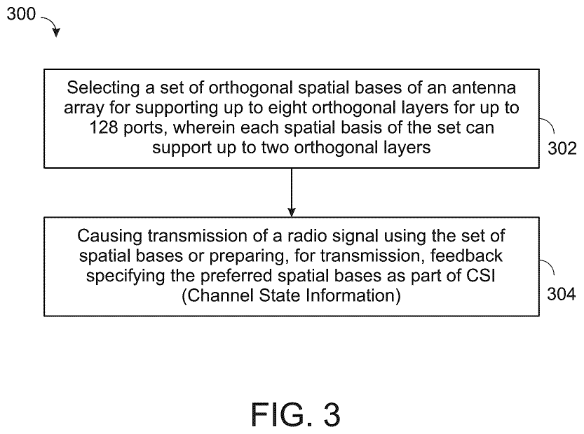

FIG. 3 illustrates a flowchart of an example process 300, according to some implementations. The process 300 includes selecting (302) a set of orthogonal spatial bases of an antenna array for supporting up to eight orthogonal layers for up to 128 ports, wherein each spatial basis of the set can support up to two orthogonal layers based on a first horizontal phase compensation factor value that is associated with a first layer of the two orthogonal layers for a first spatial basis and based on a second, opposite horizontal phase compensation factor value that is associated with a second layer of the two orthogonal layers for the first spatial basis. The process 300 includes causing (304) transmission of a radio signal using the set of spatial bases or preparing, for transmission, feedback specifying the preferred spatial bases as part of channel state information (CSI).

In some implementations, selecting the set of orthogonal spatial bases comprises reporting a set of values comprising a value of a vertical oversampling factor, a horizontal oversampling factor, a vertical spatial basis value, and a horizontal spatial basis value, the set of values representing orthogonal discrete Fourier transform (DFT) vectors.

In some implementations, the set of values for each spatial basis vᵢ is reported as

$$\{ {q}_{1}^{i} , {q}_{2}^{i} , {n}_{1}^{i} , {n}_{2}^{i} \} ,$$

where i=1, 2, 3, 4, and wherein the vertical oversampling factor and the horizontal oversampling factor are selected based on

$$\{ {q}_{1}^{i} , {q}_{2}^{i} \} = \{ {q}_{1}^{j} , {q}_{2}^{j} \} , i \neq j ,$$

where i is a horizontal spatial basis index and j is a vertical spatial basis index.

In some implementations, four spatial bases are selected for the set of orthogonal spatial bases, the method further comprising selecting, for at least two spatial bases of the four spatial bases, a same oversampling factor in a horizontal direction and, for the at least two spatial bases, selecting a different spatial basis in the horizontal direction.

In some implementations, four spatial bases are selected for the set of orthogonal spatial bases, the method further comprising selecting, for at least two spatial bases of the four spatial bases, a same oversampling factor in a vertical direction and, for the at least two spatial bases, selecting a different spatial basis in the vertical direction.

In some implementations, four spatial bases are selected for the set of orthogonal spatial bases, the method further comprising selecting, for at least two spatial bases of the four spatial bases, a same oversampling factor in a horizontal direction and in a vertical direction, and, for the at least two spatial bases, selecting a different spatial basis in the horizontal direction and/or in the vertical direction.

In some implementations, three spatial bases are selected for the set of orthogonal spatial bases for supporting rank 5, and wherein an orphan layer is allocated to a third spatial basis.

In some implementations, four spatial bases are selected for the set of orthogonal spatial bases for supporting rank 5, and wherein the first spatial basis is allocated to two layers.

In some implementations, four spatial bases are selected for the set of orthogonal spatial bases for supporting rank 5, and wherein a third spatial basis is allocated to two layers.

In some implementations, three spatial bases are selected for the set of orthogonal spatial bases for supporting rank 6, and wherein each of the three spatial bases is allocated two layers.

In some implementations, four spatial bases are selected for the set of orthogonal spatial bases for supporting rank 6, and a second spatial basis and a fourth spatial basis are allocated single layers, and wherein the first and second spatial bases are grouped in a same codeword.

In some implementations, four spatial bases are selected for the set of orthogonal spatial bases for supporting rank 6, and the first spatial basis and the second spatial basis are each allocated two layers.

In some implementations, the process 300 includes selecting a number of spatial bases from among three spatial bases or four spatial bases based on channel state information reported by a user equipment.

In some implementations, the process 300 includes selecting a number of spatial bases from among three spatial bases or four spatial bases based on a configuration by a base station.

In some implementations, the process 300 includes selecting a number of spatial bases from among three spatial bases or four spatial bases based on a predefined value.

In some implementations, four spatial bases are selected for the set of orthogonal spatial bases for supporting rank 8, and wherein each spatial bases is allocated two layers.

In some implementations, the process includes configuring an orphan layer location with at least one of the selected spatial bases using a channel state information (CSI) report. In some implementations, the CSI report specifies the orphan location in part 1.

In some implementations, the orphan layer location enables two or more layers with signal to noise ratio (SNR) values within a threshold value of each other to be grouped together in a same codeword. In some implementations, the orphan layer is a last layer for a rank 5 transmission configuration. In some implementations, the orphan layer is a third or sixth layer for a rank 6 transmission configuration. In some implementations, the orphan layer is a third layer for a rank 7 transmission configuration.

In some implementations, a last spatial basis is allocated to an orphan layer. In some implementations, a last layer and a second layer spatial basis are allocated to orphan layers. In some implementations, a user equipment indicates a spatial basis for allocation to an orphan layer.

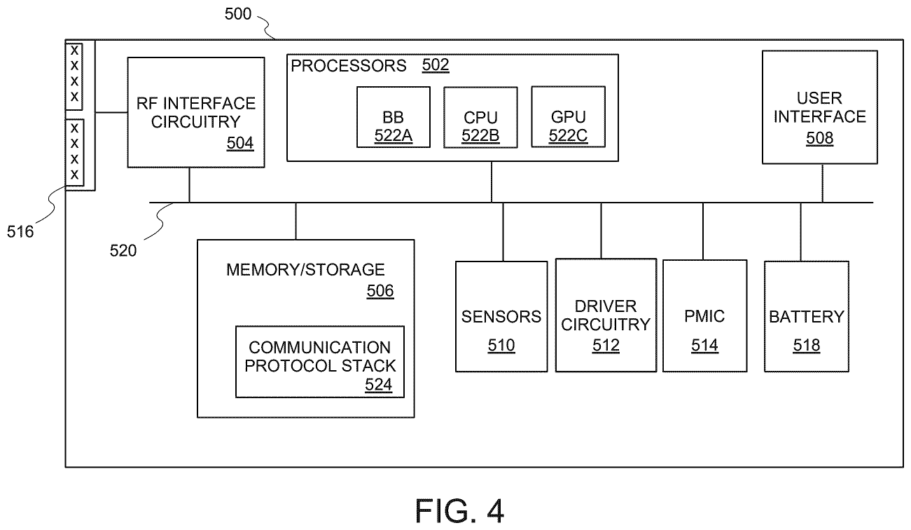

FIG. 4 illustrates a UE 500, according to some implementations. The UE 500 may be similar to and substantially interchangeable with UE 102 of FIG. 1. The UE 500 may be any mobile or non-mobile computing device, such as mobile phones, computers, tablets, industrial wireless sensors (e.g., microphones, pressure sensors, thermometers, motion sensors, accelerometers, inventory sensors, electric voltage/current meters, etc.), video devices (e.g., cameras, video cameras, etc.), wearable devices (e.g., a smart watch), relaxed-IoT devices.

The UE 500 may include processors 502, RF interface circuitry 504, memory/storage 506, user interface 508, sensors 510, driver circuitry 512, power management integrated circuit (PMIC) 514, antenna structure 516, and battery 518. The components of the UE 500 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc. that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 516. In various implementations, the RF interface circuitry 504 may be configured to transmit/receive signals in a manner compatible with NR access technologies.

The antenna 516 may include antenna elements to convert electrical signals into radio waves to travel through the air and to convert received radio waves into electrical signals. The antenna elements may be arranged into one or more antenna panels. The antenna 516 may have antenna panels that are omnidirectional, directional, or a combination thereof to enable beamforming and multiple input, multiple output communications. The antenna 516 may include microstrip antennas, printed antennas fabricated on the surface of one or more printed circuit boards, patch antennas, phased array antennas, etc. The antenna 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensor circuitry 510 and control and allow access to sensor circuitry 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

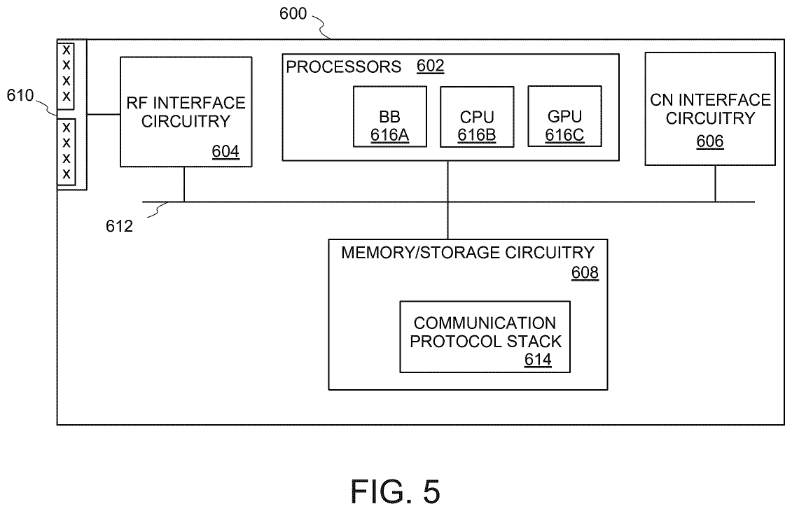

FIG. 5 illustrates an access node 600 (e.g., a base station or gNB), according to some implementations. The access node 600 may be similar to and substantially interchangeable with base station 104. The access node 600 may include processors 602, RF interface circuitry 604, core network (CN) interface circuitry 606, memory/storage circuitry 608, and antenna structure 610.

The components of the access node 600 may be coupled with various other components over one or more interconnects 612. The processors 602, RF interface circuitry 604, memory/storage circuitry 608 (including communication protocol stack 614), antenna structure 610, and interconnects 612 may be similar to like-named elements shown and described with respect to FIG. 4. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or function as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

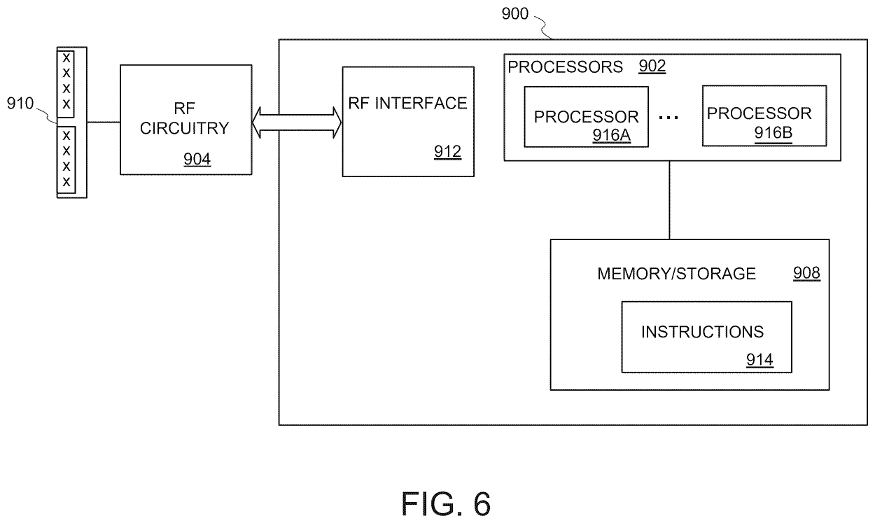

FIG. 6 is a block diagram of an example apparatus 900, according to some implementations. In some implementations, the apparatus 900 includes a baseband processor circuitry. For example, the apparatus 900 may be similar to the baseband processor circuitry (BB) 522A of FIG. 4 or the baseband processor circuitry (BB) 616A of FIG. 5 in some cases.

As shown, the apparatus 900 includes one or more processors 916A and 916B, and memory/storage 908 storing instructions 914 that are executed by the one or more processors 916A and 916B. Although FIG. 6 illustrates the apparatus 900 as having multiple processors, in some cases the apparatus 900 can include a single processor (e.g., one of processor 916A or processor 916B).

The apparatus 900 is electrically and communicatively coupled, through RF interface 912, to RF circuitry 904 and associated antenna structure 910. In some implementations, one or more of the processors 916A and 916B execute the instructions 914 to control communications through the RF circuitry 904 and antenna structure 910. In some implementations, the one or more processors 916A and 916B may be configured to encode and/or decode messages and/or instructions to control communications through the RF circuitry 904 and antenna structure 910. In some implementations, the one or more processors 916A and 916B may be configured to receive and/or prepare for transmission messages and/or instructions to control communications through the RF circuitry 904 and antenna structure 910. In some implementations, the one or more processors 916A and 916B may be configured to cause transmission of messages and/or instructions to control communications through the RF circuitry 904 and antenna structure 910. In some implementations, the apparatus 900 may comprise at least a portion of the RF circuitry 904 or may comprise the entire RF circuitry 904. For example, the one or more processors 916A and 916B may execute the instructions 914 to generate or process baseband signals or waveforms that carry information using wireless channels, and/or manage the radio functions of RF circuitry 904 and antenna structure 910, such as signal modulation, encoding, radio frequency shifting, in addition or as an alternative to the user plane or control plane functions as described with respect to the baseband processor circuitry (BB) 522A of FIG. 4 and the baseband processor circuitry (BB) 616A of FIG. 5. In doing so, the apparatus 900 enables communication, e.g., wireless cellular communication, over a 3GPP compatible network.

Additionally, in some implementations, the apparatus 900 may include wireless hardware connectivity interface(s) to send/receive data to/from Near Field Communication (NFC) components, Bluetooth® components (e.g., Bluetooth® Low Energy), Wi-Fi® components, and other communication components, and a power management interface (e.g., an interface to send/receive power). In such implementations, the instructions 914 may include instructions that, when executed by one or more of the processors 916A and 916B, cause these processors to perform Wi-Fi communications on an 802.11 network, and/or perform Bluetooth communications.

In some implementations, one or more of the processors 916A and 916B is a 3G baseband processor, a 4G baseband processor, a 5G baseband processor, or other suitable baseband processor. In some implementations, one or more of the processors 916A and 916B may be configured as an FPGA (Field Programmable Gate Array), and/or may have dedicated hardware components, which may include an ASIC (Application Specific Integrated Circuit).

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 800; a MAC/PHY split wherein RRC, PDCP, RLC, and MAC layers are operated by the CRAN/vBBUP and the PHY layer is operated by the access node 800; or a “lower PHY” split wherein RRC, PDCP, RLC, MAC layers and upper portions of the PHY layer are operated by the CRAN/vBBUP and lower portions of the PHY layer are operated by the access node 800.

In V2X scenarios, the access node 800 may be or act as RSUs. The term “RoadSide Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

### Examples

Example 1 includes a method for wireless communication, the method comprising: selecting a set of orthogonal spatial bases of an antenna array for supporting up to eight orthogonal layers for up to 128 ports, wherein each spatial basis of the set can support up to two orthogonal layers based on a first horizontal phase compensation factor value that is associated with a first layer of the two orthogonal layers for a first spatial basis and based on a second, opposite horizontal phase compensation factor value that is associated with a second layer of the two orthogonal layers for the first spatial basis; and causing transmission of a radio signal using the set of spatial bases, or preparing, for transmission, feedback specifying the preferred spatial bases as part of Channel State Information (CSI).

Example 2 includes the method of example 1, wherein selecting the set of orthogonal spatial bases comprises reporting a set of values comprising a value of a vertical oversampling factor, a horizontal oversampling factor, a vertical spatial basis value, and a horizontal spatial basis value, the set of values representing orthogonal discrete Fourier transform (DFT) vectors.

Example 3 includes the method of example 2, wherein the set of values for each spatial basis vᵢ is reported as

$$\{ {q}_{1}^{i} , {q}_{2}^{i} , {n}_{1}^{i} , {n}_{2}^{i} \} ,$$

where i=1, 2, 3, 4, and wherein the vertical oversampling factor and the horizontal oversampling factor are selected based on

$$\{ {q}_{1}^{i} , {q}_{2}^{i} \} = \{ {q}_{1}^{j} , {q}_{2}^{j} \} , i \neq j ,$$

where i is a horizontal spatial basis index and j is a vertical spatial basis index.

Example 4 includes the method of any of examples 1 through 3, wherein four spatial bases are selected for the set of orthogonal spatial bases, the method further comprising selecting, for at least two spatial bases of the four spatial bases, a same oversampling factor in a horizontal direction and, for the at least two spatial bases, selecting a different spatial basis in the horizontal direction.

Example 5 includes the method of any of examples 1 through 3, wherein four spatial bases are selected for the set of orthogonal spatial bases, the method further comprising selecting, for at least two spatial bases of the four spatial bases, a same oversampling factor in a vertical direction and, for the at least two spatial bases, selecting a different spatial basis in the vertical direction.

Example 6 includes the method of any of examples 1 through 3, wherein four spatial bases are selected for the set of orthogonal spatial bases, the method further comprising selecting, for at least two spatial bases of the four spatial bases, a same oversampling factor in a horizontal direction and in a vertical direction, and, for the at least two spatial bases, selecting a different spatial basis in the horizontal direction and/or in the vertical direction.

Example 7 includes the method of any of examples 1 through 3, wherein three spatial bases are selected for the set of orthogonal spatial bases for supporting rank 5, and wherein an orphan layer is allocated to a third spatial basis.

Example 8 includes the method of any of examples 1 through 3, wherein four spatial bases are selected for the set of orthogonal spatial bases for supporting rank 5, and wherein the first spatial basis is allocated to two layers.

Example 9 includes the method of any of examples 1 through 3, wherein four spatial bases are selected for the set of orthogonal spatial bases for supporting rank 5, and wherein a third spatial basis is allocated to two layers.

Example 10 includes the method of any of examples 1 through 3, wherein three spatial bases are selected for the set of orthogonal spatial bases for supporting rank 6, and wherein each of the three spatial bases is allocated two layers.

Example 11 includes the method of any of examples 1 through 10, wherein four spatial bases are selected for the set of orthogonal spatial bases for supporting rank 6, and a second spatial basis and a fourth spatial basis are allocated single layers, and wherein the first and second spatial bases are grouped in a same codeword.

Example 12 includes the method of any of examples 1 through 3, wherein four spatial bases are selected for the set of orthogonal spatial bases for supporting rank 6, and the first spatial basis and the second spatial basis are each allocated two layers.

Example 13 includes the method of any of examples 1 through 12, further comprising selecting a number of spatial bases from among three spatial bases or four spatial bases based on channel state information reported by a user equipment.

Example 14 includes the method of any of examples 1 through 12, further comprising selecting a number of spatial bases from among three spatial bases or four spatial bases based on a configuration by a base station.

Example 15 includes the method of any of examples 1 through 12, further comprising selecting a number of spatial bases from among three spatial bases or four spatial bases based on a predefined value.

Example 16 includes the method of any of examples 1 through 3, wherein four spatial bases are selected for the set of orthogonal spatial bases for supporting rank 8, and wherein each spatial bases is allocated two layers.

Example 17 includes the method of any of examples 1 through 15, further comprising configuring an orphan layer location with at least one of the selected spatial bases using a channel state information (CSI) report.

Example 18 includes the method of example 17, wherein the CSI report specifies the orphan location in part 1.

Example 19 includes the method of example 17, wherein the orphan layer location enables two or more layers with signal to noise ratio (SNR) values within a threshold value of each other to be grouped together in a same codeword.

Example 20 includes the method of example 17, wherein the orphan layer is a last layer for a rank 5 transmission configuration.

Example 21 includes the method of example 17, wherein the orphan layer is a third or sixth layer for a rank 6 transmission configuration.

Example 22 includes the method of example 17, wherein the orphan layer is a third layer for a rank 7 transmission configuration.

Example 23 includes the method of example 1, wherein a last spatial basis is allocated to an orphan layer.

Example 24 includes the method of example 23, wherein multiple spatial basis are allocated to orphan layers.

Example 25 includes the method of any of examples 1 through 24, wherein a user equipment indicates a spatial basis for allocation to an orphan layer.

Example 26 includes the method of any of examples 1 through 24, wherein particular, fixed layer is allocated to an orphan layer.

Example 27 includes a non-transitory computer storage medium encoded with instructions that, when executed by one or more computers, cause the one or more computers to perform the method of any preceding example.

Example 28 includes a system comprising one or more processors and one or more storage devices on which are stored instructions that are operable, when executed by the one or more processors, to cause the one or more processors to perform the method of any of examples 1 to 26.

Example 29 includes an apparatus comprising one or more baseband processors configured to perform the method of any of examples 1 to 26.

Example 30 includes one or more processors comprising circuitry that executes instructions to cause a user equipment (UE) to perform the method of any of examples 1 to 26.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. One or more processors for wireless communication, the one or more processors configured to perform operations comprising:
selecting a set of spatial bases of an antenna array for supporting up to eight orthogonal layers for up to 128 ports, wherein each spatial basis of the set can support up to two orthogonal layers based on a first horizontal phase compensation factor value that is associated with a first layer of the two orthogonal layers for a first spatial basis and based on a second, opposite horizontal phase compensation factor value that is associated with a second layer of the two orthogonal layers for the first spatial basis; and
causing transmission of a radio signal using the set of spatial bases, or
outputting, for transmission, feedback specifying the set of spatial bases as part of Channel State Information (CSI).

2. The one or more processors of claim 1, wherein selecting the set of spatial bases comprises reporting a set of values comprising a value of a vertical oversampling factor, a horizontal oversampling factor, a vertical spatial basis value, and a horizontal spatial basis value, the set of values representing orthogonal discrete Fourier transform (DFT) vectors.

3. The one or more processors of claim 2, wherein the set of values for each spatial basis vᵢ is reported as
$$\{ {q}_{1}^{i} , {q}_{2}^{i} , {n}_{1}^{i} , {n}_{2}^{i} \} ,$$
where i=1, 2, 3, 4, and wherein the vertical oversampling factor and the horizontal oversampling factor are selected based on
$$\{ {q}_{1}^{i} , {q}_{2}^{i} \} = \{ {q}_{1}^{j} , {q}_{2}^{j} \} , i \neq j ,$$
where i is a horizontal spatial basis index and j is a vertical spatial basis index.

4. The one or more processors of claim 1, wherein four spatial bases are selected for the set of spatial bases, the operations further comprising selecting, for at least two spatial bases of the four spatial bases, a same oversampling factor in a horizontal direction and, for the at least two spatial bases, selecting a different spatial basis in the horizontal direction.

5. The one or more processors of claim 1, wherein four spatial bases are selected for the set of spatial bases, the operations further comprising selecting, for at least two spatial bases of the four spatial bases, a same oversampling factor in a vertical direction and, for the at least two spatial bases, selecting a different spatial basis in the vertical direction.

6. The one or more processors of claim 1, wherein four spatial bases are selected for the set of spatial bases, the operations further comprising selecting, for at least two spatial bases of the four spatial bases, a same oversampling factor in a horizontal direction and in a vertical direction, and, for the at least two spatial bases, selecting a different spatial basis in the horizontal direction and/or in the vertical direction.

7. The one or more processors of claim 1, wherein three spatial bases are selected for the set of spatial bases for supporting rank 5, and wherein an orphan layer is allocated to a third spatial basis.

8. The one or more processors of claim 1, wherein four spatial bases are selected for the set of spatial bases for supporting rank 5, and wherein the first spatial basis is allocated to two layers or wherein a third spatial basis is allocated to two layers.

9. The one or more processors of claim 1, wherein three spatial bases are selected for the set of spatial bases for supporting rank 6, and wherein each of the three spatial bases is allocated two layers.

10. The one or more processors of claim 1, wherein four spatial bases are selected for the set of spatial bases for supporting rank 6, and a second spatial basis and a fourth spatial basis are allocated single layers, and wherein the first and second spatial bases are grouped in a same codeword.

11. The one or more processors of claim 1, wherein four spatial bases are selected for the set of spatial bases for supporting rank 6, and the first spatial basis and the second spatial basis are each allocated two layers.

12. The one or more processors of claim 1, further comprising selecting a number of spatial bases from among three spatial bases or four spatial bases based on channel state information reported by a user equipment.

13. The one or more processors of claim 1, further comprising selecting a number of spatial bases from among three spatial bases or four spatial bases based on a configuration by a base station.

14. The one or more processors of claim 1, wherein four spatial bases are selected for the set of spatial bases for supporting rank 8, and wherein each spatial bases is allocated two layers so that four spatial bases are allocated and reported.

15. The one or more processors of claim 1, further comprising configuring an orphan layer location with at least one of the set of spatial bases using a channel state information (CSI) report.

16. The one or more processors of claim 15, wherein the orphan layer is a last layer for a rank 5 transmission configuration;
wherein the orphan layer is a third or sixth layer for a rank 6 transmission configuration; or
wherein the orphan layer is a third layer for a rank 7 transmission configuration.

17. The one or more processors of claim 1, wherein a particular, fixed spatial basis is allocated to an orphan layer.

18. The one or more processors of claim 1, wherein multiple spatial bases are allocated to orphan layers and indicated by a user equipment.

19. An access node comprising circuitry that executes instructions to perform operations comprising:
sending a channel state information (CSI) reference signal; and
receiving feedback specifying a selected set of spatial bases as part of CSI; or
receiving a radio signal transmitted using the selected set of spatial bases,
the selected spatial bases being selected from a set of spatial bases of an antenna array for supporting up to eight orthogonal layers for up to 128 ports, wherein each spatial basis of the set supports up to two orthogonal layers based on a first horizontal phase compensation factor value that is associated with a first layer of the two orthogonal layers for a first spatial basis and based on a second, opposite horizontal phase compensation factor value that is associated with a second layer of the two orthogonal layers for the first spatial basis.

20. A method for wireless communication, the method comprising:
selecting a set of spatial bases of an antenna array for supporting up to eight orthogonal layers for up to 128 ports, wherein each spatial basis of the set can support up to two orthogonal layers based on a first horizontal phase compensation factor value that is associated with a first layer of the two orthogonal layers for a first spatial basis and based on a second, opposite horizontal phase compensation factor value that is associated with a second layer of the two orthogonal layers for the first spatial basis; and
causing transmission of a radio signal using the set of spatial bases, or
outputting, for transmission, feedback specifying the set of spatial bases as part of Channel State Information (CSI).
